(19) United States
(12) Patent Application Publication
(10) Pub. No.: US 2013/0341558 A1
(43) Pub. Date: Dec. 26, 2013

(54) ETCHING SOLUTION FOR COPPER LEAD OF TFT ARRAY SUBSTRATE

(71) Applicant: Hao Kou, Shenzhen (CN)

(72) Inventor: Hao Kou, Shenzhen (CN)

(73) Assignee: SHENZHEN CHINA STAR OPTOELECTRONICS TECHNOLOGY CO. LTD., Shenzhen (CN)

(21) Appl. No.: 13/583,225

(22) PCT Filed: Jul. 6, 2012
(86) PCT No.: PCT/CN12/78260

§ 371 Date: Sep. 7, 2012

(30) Foreign Application Priority Data
Jun. 26, 2012 (CN) 201210213150.1

(51) Int. Cl. C09K 13/06

(52) U.S. Cl. CPC C09K 13/06
USPC 252/79.4

(57) ABSTRACT

The present invention relates to an etching solution for copper lead of TFT array substrate, which includes: primary oxidant, secondary oxidant, chelating agent, inhibitor, and additive. The primary oxidant is hydrogen peroxide and the secondary oxidant is phosphoric acid, sulfuric acid, and nitric acid. The chelating agent is amino compound. The inhibitor is amino azole compound and carboxylate compound. The additive is amine compound containing amino nitrogen and coordinating carboxylate oxygen atom. Through adoption of novel components and types of chelating agent and additive, the etching solution improves the characteristics of relatively short process window for copper lead etching solution, reduces the difficult of engineering control, improves stability of engineering operation and improves yield rate, increases stability of shelf time to thereby provide stable etching performance even in the rear half of shelf time, and extends lifespan (≧5000 ppm).

### BACKGROUND OF THE INVENTION

1. Field of the Invention

The present invention relates to the field of etching solution, and in particular to an etching solution for copper lead of TFT (Thin-Film Transistor) array substrate.

2. The Related Arts

Liquid crystal display (LCD) has a variety of advantages, such as thin device body, low power consumption, and being free of radiation, and is thus widely used. The LCDs that are currently available in the market comprise a liquid crystal display panel and a backlight module. The liquid crystal display panel generally comprises a CF (Color Filter) substrate, a TFT (Thin-Film Transistor) array substrate, and liquid crystal interposed between the CF substrate and the TFT array substrate. By applying electricity to the TFT array substrate to control variation of direction of the liquid crystal molecules, light from the backlight module is projected to the CF substrate to generate an image.

The performance and features and operation characteristics of the TFT array substrate are determined, to a great extent, by the materials that are used to make the components of the TFT array substrate. Metal leads are laid on the TFT array substrate and the metal leads are formed through an etching operation carried out on a metal layer that is coated on the TFT array substrate by sputtering. The etching operation is divided into dry etching and wet etching. The metal lead that normally used in the TFT array substrate is aluminum lead. With the development trend and demand of liquid crystal display terminal, such as television, for size increase, high definition, and high driving frequency, the technical personnel in the liquid crystal displaying field is forced to face the resistivity of TFT array substrate and the problem of delay of resistance/capacitance time caused thereby. Aluminum lead has a high resistivity (around 4 Ωm) and this makes it not possible for pixel electrodes of TFT array substrate to sufficiently charged. This issue gets more severe with the widened application of high frequency addressing (≧120 Hz) liquid crystal displaying.

Compared to aluminum lead, copper lead has a relatively low resistivity (around 2 Ωm) and has excellent property against electrical migration and is thus applied to TFT array substrate to overcome the problems caused by aluminum lead. However, during an etching process of copper lead, after being subjected to reactive ion etch (RIE), metal copper may become copper fluoride (CuFₓ) and copper chloride (CuClₓ). Such a product is solid below 200° C. and does not gasify. Consequently, metal copper cannot be dry-etched in the same way as metal aluminum to form lead pattern. Thus, developing an etching solution for wet etching of metal copper becomes very important.

Further, copper shows poor adherence to glass and must be transitioned with a lower metal layer. Further, copper is easy to react with silicon through diffusion at a temperature below 200° C. so as to form a product of CuSi₃, which causes an extremely high contact resistance. Consequently, a lower layer of other metal must be used for transitioning. A hard-to-melt metal, such as molybdenum (Mo) and titanium (Ti), is commonly used to serve as the transitioning adhering layer and blocking layer. A metal layer that is suitable for the copper lead of TFT array substrate, as well as a corresponding copper lead etching solution, must be developed.

U.S. Patent Nos. 20010983733, 2002076930A1, 20080079008, and 2009286360A1 disclose Cu/Mo and Cu/Ti metal structures that have been used in mass production in this industry. In view of the copper lead manufacturing process that is conventionally used in mass production and production yield rate thereof, a hydrogen peroxide (H₂O₂) based Cu etching solution shows a distinct advantage but the following disadvantages still exit:

(1) The etching solution often shows the characteristics of short process window in etching metal layer and this increased the difficult of engineering control and may severely affect stability and yield rate of engineering production.

(2) The conventional copper lead etching solution often shows instability of shelf time and has the drawbacks of unstable etching performance and reduced process window in the rear half of shelf time.

(3) The lifespan is relatively short (≦3000 ppm) and shows the drawbacks of the process window becoming narrowed, the performance getting unstable, and showing increased CD loss in the rear half of the manufacturing process.

### SUMMARY OF THE INVENTION

An object of the present invention is to provide an etching solution for copper lead of TFT array substrate, which shows a wide process window, a long shelf time, and an extended etching life.

To achieve the object, the present invention provides an etching solution for copper lead of TFT array substrate, comprising: primary oxidant, secondary oxidant, chelating agent, inhibitor, and additive, wherein the primary oxidant is hydrogen peroxide and the secondary oxidant is phosphoric acid, sulfuric acid, and nitric acid; the chelating agent is amino compound; the inhibitor is amino azole compound and carboxylate compound; the additive is amine compound comprising amino nitrogen and coordinating carboxylate oxygen atom.

Based on 100% of total volume of the etching solution, the primary oxidant is in an amount of 3-10%, the secondary oxidant is in an amount of 6-25%, the chelating agent is in an amount of 7-11%, the inhibitor is in an amount of 3-5%, and the additive is in an amount of 0.5-2%.

The amino compound comprises two or more than two coordinating atoms.

The amino compound is iminodiacetic acid or triethylenetetramine.

A chelate compound formed by chelation of iminodiacetic acid with copper ion or molybdenum ion has a formula as follows:

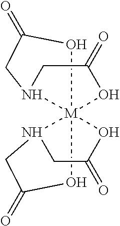

wherein M is copper ion or molybdenum ion.

The amine compound is at least one of triethanolamines.

The amino azole compound is amino tetrazole.

The carboxylate compound is ethylene diamine tetraacetic acid or cyclohexane-diamine-tetraacetic acid.

The etching solution further comprises a solvent, wherein the solvent is deionized water and is of a residual volume that is 100% total volume of the etching solution minus the primary oxidant, the secondary oxidant, the chelating agent, the inhibitor, and the additive.

The present invention also provides an etching solution for copper lead of TFT array substrate, comprising: primary oxidant, secondary oxidant, chelating agent, inhibitor, and additive, wherein the primary oxidant is hydrogen peroxide and the secondary oxidant is phosphoric acid, sulfuric acid, and nitric acid; the chelating agent is amino compound; the inhibitor is amino azole compound and carboxylate compound; the additive is amine compound comprising amino nitrogen and coordinating carboxylate oxygen atom;

wherein in 100% of total volume of the etching solution, the primary oxidant is in an amount of 3-10%, the secondary oxidant is in an amount of 6-25%, the chelating agent is in an amount of 7-11%, the inhibitor is in an amount of 3-5%, and the additive is in an amount of 0.5-2%;

wherein the amino compound comprises two or more than two coordinating atoms;

wherein the amino compound is iminodiacetic acid;

wherein a chelate compound formed by chelation of iminodiacetic acid with copper ion or molybdenum ion has a formula as follows:

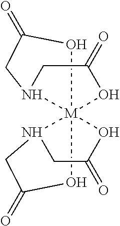

M being copper ion or molybdenum ion;

wherein the amine compound is at least one of triethanolamines;

wherein the amino azole compound is amino tetrazole;

wherein the carboxylate compound is ethylene diamine tetraacetic acid or cyclohexane-diamine-tetraacetic acid; and

further comprising a solvent, wherein the solvent is deionized water and is of a residual volume that is 100% total volume of the etching solution minus the primary oxidant, the secondary oxidant, the chelating agent, the inhibitor, and the additive.

The efficacy of the present invention is that through adoption of novel components and types of chelating agent and additive, the present invention significantly improves the characteristics of relatively short process window for copper lead etching solution, reduces the difficult of engineering control, improves stability of engineering operation and improves yield rate, increases stability of shelf time to thereby provide stable etching performance even in the rear half of shelf time, extends lifespan (5000 ppm) with the process window being not remarkably narrowed in the rear half of the process and performance being maintained stable.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 shows relationship among taper angle, CD-loss, and etching time for an etching solution according to the present invention used to etch a metal layer;

FIG. 2 is a photo of etching for 180% OE (Over Etching) of last week of shelf time;

FIG. 3 shows relationship among taper angle, CD-loss, and etching time for the etching solution according to the present invention at 5000 ppm etching life;

FIG. 4 is a photo of etching for 180% OE at 5000 ppm etching life for the etching solution according to the present invention;

FIG. 5 is a photo of etching for JET (Just Etching Time) according to an embodiment of the present invention;

FIG. 6 is a photo of etching for 120%/OE according to an embodiment of the present invention; and

FIG. 7 is a photo of etching for 180%/OE according to an embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

The present invention provides an etching solution for copper lead of TFT array substrate, which is generally applied to metal structures of Cu/Mo and Cu/Mo alloys. The metal alloys may comprise materials including Mg, Al, Ni, V, Mn, or Si with a molybdenum layer or molybdenum alloy layer serving as a lower layer metal to improve the adherence of the lower layer metal to glass and the blocking performance and also providing an effect of electrode potential for stably blocking the metal layer in the etching solution. The etching solution comprises a primary oxidant, a secondary oxidant, a chelating agent, an inhibitor, and an additive. The primary oxidant is hydrogen peroxide and the secondary oxidant is phosphoric acid, sulfuric acid, and nitric acid. The chelating agent is amino compound. The inhibitor is amino azole compound and carboxylate compound. The additive is amine compound comprising amino nitrogen and coordinating carboxylate oxygen atom.

Based on 100% of total volume of the etching solution, the primary oxidant is in an amount of 3-10%, the secondary oxidant is in an amount of 6-25%, the chelating agent is in an amount of 7-11%, the inhibitor is in an amount of 3-5%, and the additive is in an amount of 0.5-2%.

Said hydrogen peroxide is used as the primary oxidant of the etching solution to react with Cu and Mo for generating metal oxides. MoO₃ may be effectively combined with the chelating agent and other additives to form a stable complex, yet CuO shows a poor power of combining with the chelating agent, the inhibitor, and the additive and is difficult to form a stable compound and may facilitate evaporation of H₂O₂.

The secondary oxidant is phosphoric acid, sulfuric acid, and nitric acid, which may cause further reaction with CuO to form Cu²⁺ for easy formation of a stable compound with the chelating agent, the inhibitor, and the additive.

The chelating agent comprises two or more than two coordinating atoms for chelating and controlling the metal ions that are released through etching by the oxidants. A multidentate ligand comprising multiple bondable atoms is adopted as the chelating agent. During the etching process, the chelating agent is combined with the metal ions to form a chelate compound having a “coordinating ring structure”. In the chelating process, generally, a five-member ring and a six-member ring are most stable. This may effectively alleviate or even eliminate stepwise complex phenomenon.

The amino compound comprises iminodiacetic acid or triethylenetetramine. Iminodiacetic acid may chelate cupper ions or molybdenum ions to form a chelate compound having a formula as follows:

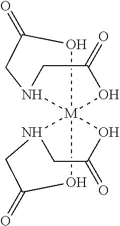

wherein M is copper ion or molybdenum ion.

The inhibitor comprises amino azole compound and carboxylate compound. The amino azole compound is amino tetrazole and the carboxylate compound is ethylene diamine tetraacetic acid or cyclohexane-diamine-tetraacetic acid. The inhibitor functions to control etching performance of for example taper angle. Amino nitrogen and coordinating carboxylate oxygen atom contained in the molecule shows a strong coordinating power and can essentially perform a complexation reaction with all the metallic material contained in the metal alloys.

The amine compound comprises amino nitrogen and coordinating carboxylate oxygen atom and is at least one of triethanolamines, which may decompose to release amino groups of different contents with the progress of etching for combining with Cu²⁺ released by the etching operation and may effectively inhibit the decomposition of the chelate compound formed previously by Cu²⁺ and the chelating agent so as to ensure effectively chelation of the chelating agent with the metal ions and reducing impregnation of the etching solution and excessive attack against the metal layer during the etching process thereby providing a wider process window and complying with requirement of technical specifications, such as tape angle and CD-loss.

The etching solution may comprise a solvent, which is deionized water and is of a residual volume that is 100% total volume of the etching solution minus the primary oxidant, the secondary oxidant, the chelating agent, the inhibitor, and the additive.

In an engineering application, when the metal ions contained in the etching solution reaches 2500 pm, addition is made in a proportional manner in order to extend the etching life of the etching solution to around 5000 ppm.

The primary performance of the etching solution for copper lead includes:

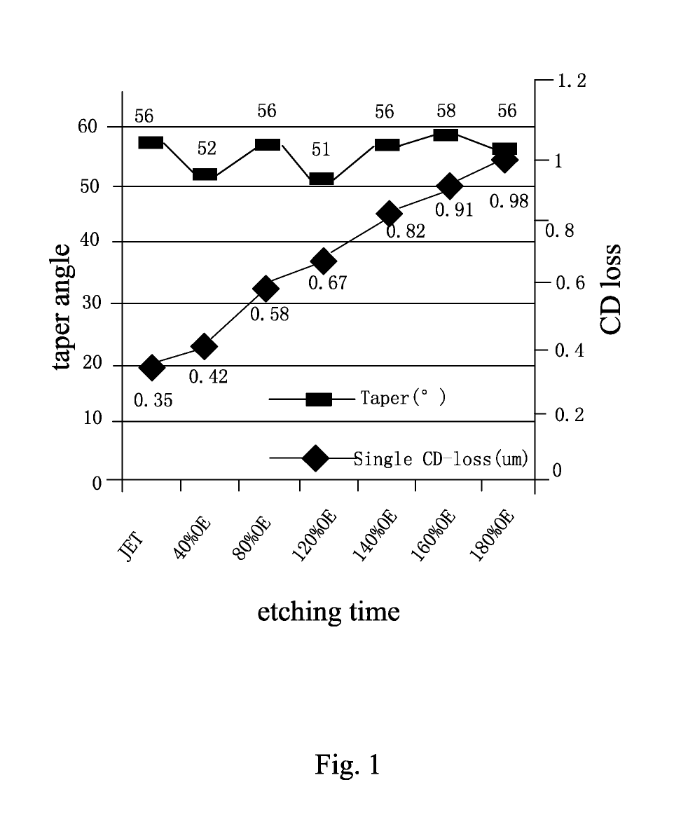

(1) As shown in FIG. 1, a summary of the performance of the etching solution for copper lead according to the present invention and process window are given. It is noted that a wide process window is formed between JET (Just Etching Time) and OE (Over Etching) that is 180% in compliance with specification requirement so as to help inducing stability.

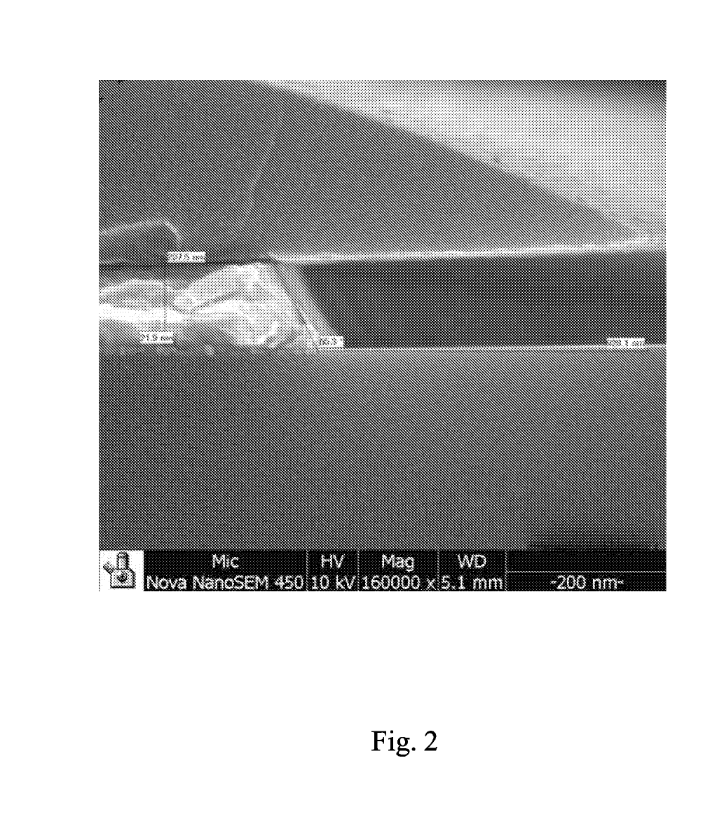

(2) As shown in FIG. 2, the etching solution still shows good performance during the rear half of the shelf time.

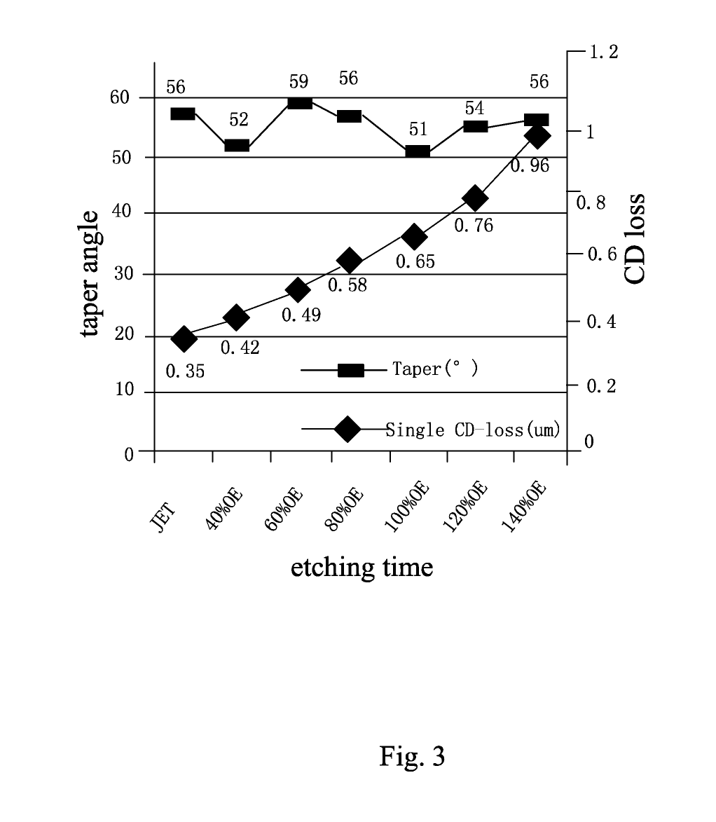

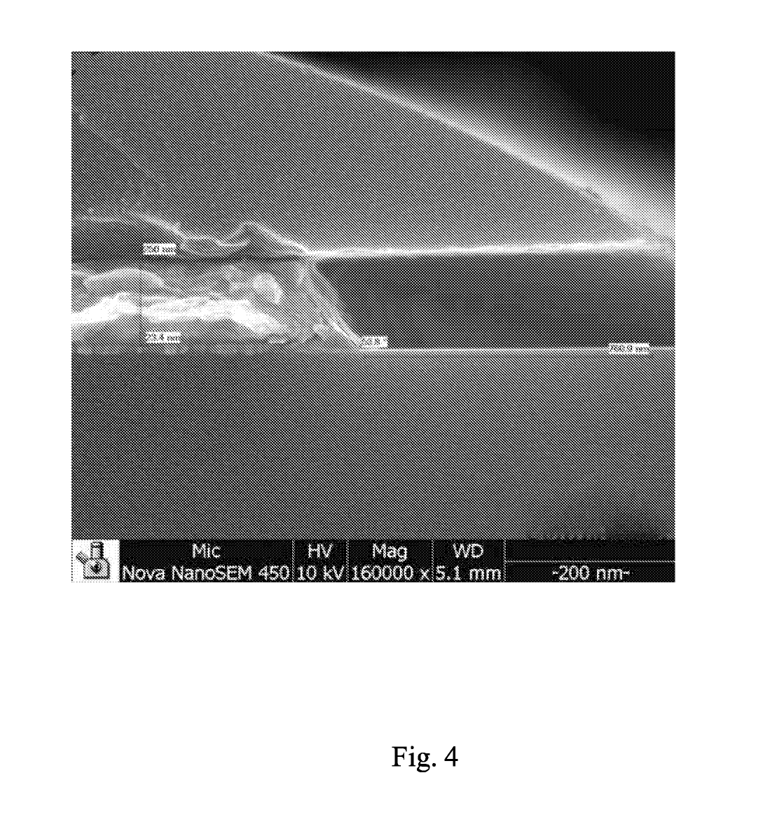

(3) As shown in FIGS. 3 and 4, the etching solution has an extended etching lift and may shows good etching result, wide process window, and good performance at 5000 ppm.

In summary, through adoption of novel components and types of chelating agent and additive, the present invention significantly improves the characteristics of relatively short process window for copper lead etching solution, reduces the difficult of engineering control, improves stability of engineering operation and improves yield rate, increases stability of shelf time to thereby provide stable etching performance even in the rear half of shelf time, extends lifespan (≧5000 ppm) with the process window being not remarkably narrowed in the rear half of the process and performance being maintained stable. An example is given below for describing the technical result obtained with the present invention.

A TFT array substrate is subjected to sputtering to form a copper film of 2500 Å and a molybdenum alloy film of 200 Å. The specification is set that the process window is 90%/OE. The process window for the etching solution according to the present invention is listed in Table 1 below:

TABLE 1
Major Performance Behaviors of the Etching Solution According
to the Present Invention Etching Metal Layer

| | | Sample Number | | | | | | |
|---|---|---|---|---|---|---|---|---|
| | Requirement | #1 | #2 | #3 | #4 | #5 | #6 | #7 |
| Etching | 80% | JET | 40% | 80% | 120% | 140% | 1600% | 180% |
| Time (%) | | | OD | OD | OD | OD | OD | OD |
| Single | ≦1.000 | 0.325 | 0.462 | 0.587 | 0.761 | 0.838 | 0.928 | 1.069 |
| CD-Loss | | | | | | | | |
| (um) | | | | | | | | |
| Taper (°) | ≦60.0 | 56.9 | 53.9 | 54.9 | 53.8 | 51.6 | 65.3 | 57.1 |

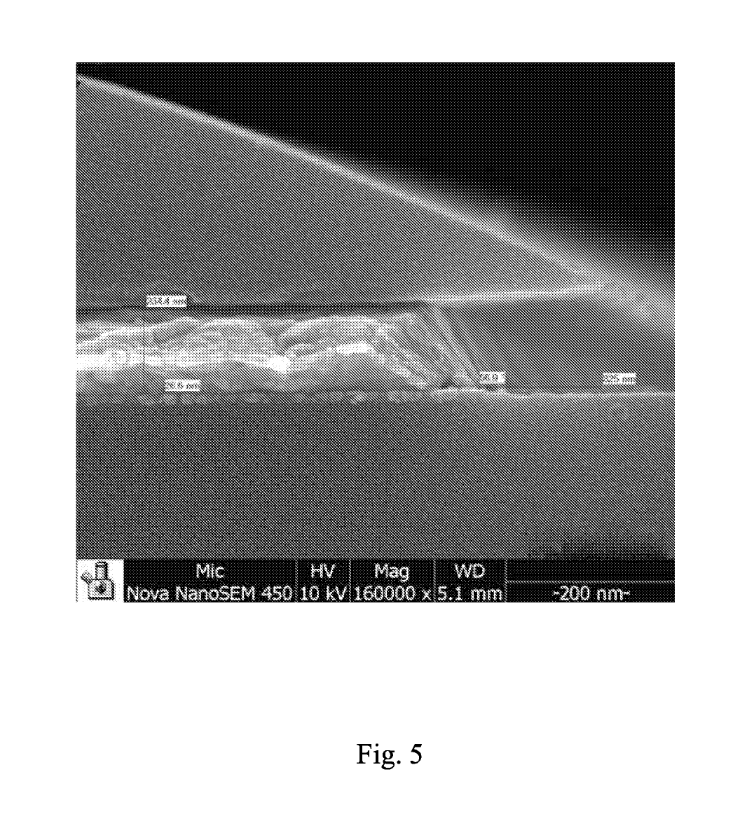

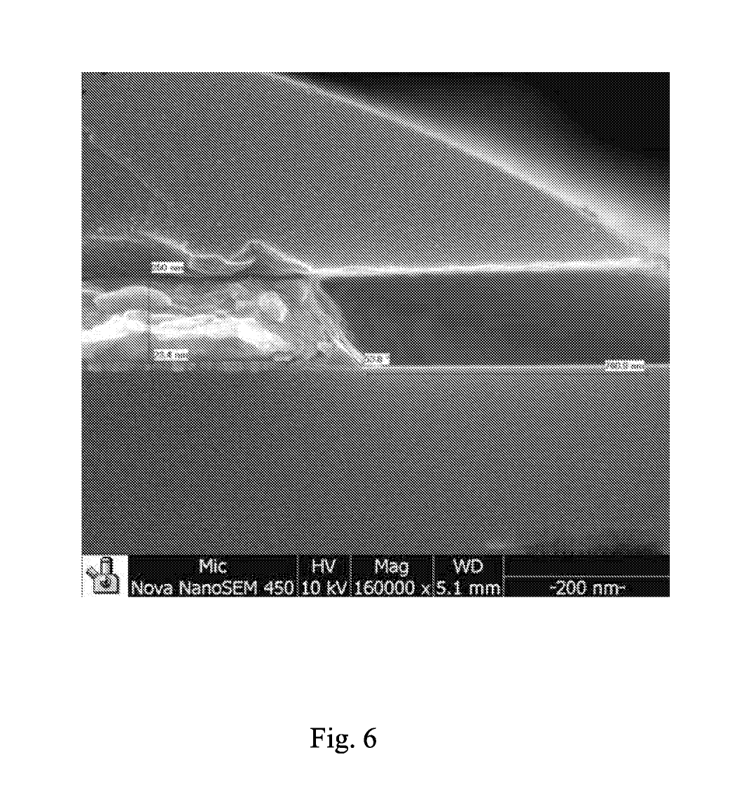

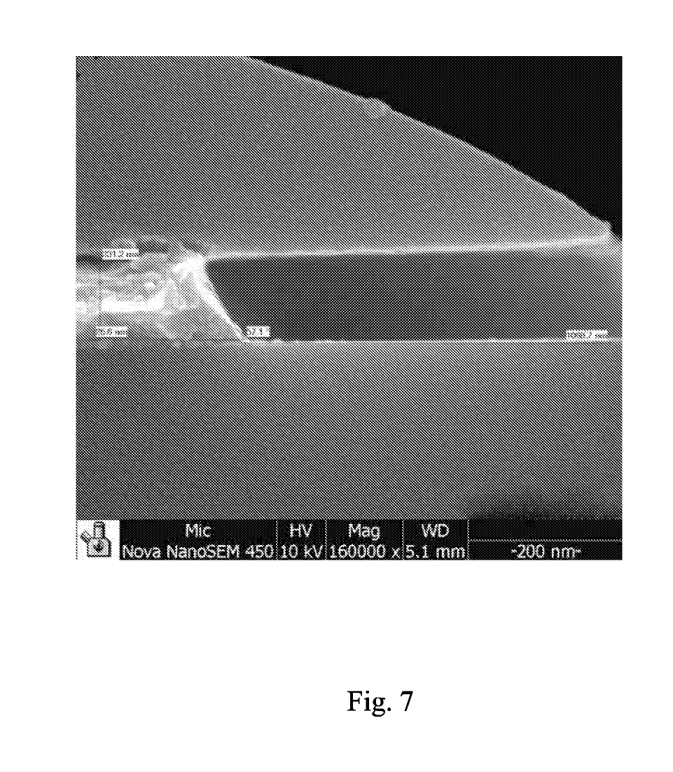

Referring to FIGS. 5-7, in using a sample etching solution of the present invention to etch a metal layer, at the etching time of JET, 120% OD, and 180% OD, the sample etching solution shows excellent result of etching and good performance.

Based on the description given above, those having ordinary skills of the art may easily contemplate various changes and modifications of the technical solution and technical ideas of the present invention and all these changes and modifications are considered within the protection scope of right for the present invention.

What is claimed is:

1. An etching solution for copper lead of TFT array substrate, comprising: primary oxidant, secondary oxidant, chelating agent, inhibitor, and additive, wherein the primary oxidant is hydrogen peroxide and the secondary oxidant is phosphoric acid, sulfuric acid, and nitric acid; the chelating agent is amino compound; the inhibitor is amino azole compound and carboxylate compound; the additive is amine compound comprising amino nitrogen and coordinating carboxylate oxygen atom.

2. The etching solution for copper lead of TFT array substrate as claimed in claim 1, wherein in 100% of total volume of the etching solution, the primary oxidant is in an amount of 3-10%, the secondary oxidant is in an amount of 6-25%, the chelating agent is in an amount of 7-11%, the inhibitor is in an amount of 3-5%, and the additive is in an amount of 0.5-2%.

3. The etching solution for copper lead of TFT array substrate as claimed in claim 1, wherein the amino compound comprises two or more than two coordinating atoms.

4. The etching solution for copper lead of TFT array substrate as claimed in claim 3, wherein the amino compound is iminodiacetic acid or triethylenetetramine.

5. The etching solution for copper lead of TFT array substrate as claimed in claim 4, wherein a chelate compound formed by chelation of iminodiacetic acid with copper ion or molybdenum ion has a formula as follows: 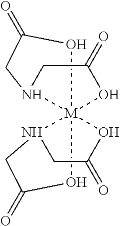
wherein M is copper ion or molybdenum ion.

6. The etching solution for copper lead of TFT array substrate as claimed in claim 1, wherein the amino compound is at least one of triethanolamines.

7. The etching solution for copper lead of TFT array substrate as claimed in claim 1, wherein the amino azole compound is amino tetrazole.

8. The etching solution for copper lead of TFT array substrate as claimed in claim 1, wherein the carboxylate compound is ethylene diamine tetraacetic acid or cyclohexane-diamine-tetraacetic acid.

9. The etching solution for copper lead of TFT array substrate as claimed in claim 2 further comprising a solvent, wherein the solvent is deionized water and is of a residual volume that is 100% total volume of the etching solution minus the primary oxidant, the secondary oxidant, the chelating agent, the inhibitor, and the additive.

10. An etching solution for copper lead of TFT array substrate, comprising: primary oxidant, secondary oxidant, chelating agent, inhibitor, and additive, wherein the primary oxidant is hydrogen peroxide and the secondary oxidant is phosphoric acid, sulfuric acid, and nitric acid; the chelating agent is amino compound; the inhibitor is amino azole compound and carboxylate compound; the additive is amine compound comprising amino nitrogen and coordinating carboxylate oxygen atom;
wherein in 100% of total volume of the etching solution, the primary oxidant is in an amount of 3-10%, the secondary oxidant is in an amount of 6-25%, the chelating agent is in an amount of 7-11%, the inhibitor is in an amount of 3-5%, and the additive is in an amount of 0.5-2%;
wherein the amine compound comprises two or more than two coordinating atoms;
wherein the amine compound is iminodiacetic acid;
wherein a chelate compound formed by chelation of iminodiacetic acid with copper ion or molybdenum ion has a formula as follows: 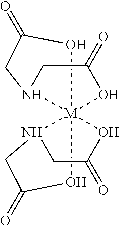
M being copper ion or molybdenum ion;
wherein the amine compound is at least one of triethanolamines;
wherein the amino azole compound is amino tetrazole;
wherein the carboxylate compound is ethylene diamine tetraacetic acid or cyclohexane-diamine-tetraacetic acid; and
further comprising a solvent, wherein the solvent is deionized water and is of a residual volume that is 100% total volume of the etching solution minus the primary oxidant, the secondary oxidant, the chelating agent, the inhibitor, and the additive.
